(19) United States
(12) Patent Application Publication
(10) Pub. No.: US 2006/0271379 A1
(43) Pub. Date: Nov. 30, 2006

(54) Intellectual property analysis and report generating system and method

(76) Inventors: Jason Resnick, Alexandria, VA (US); David R. Mandel, Williamsville, NY (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/137,488

(22) Filed: May 26, 2005

(51) Int. Cl. G06Q 99/00

(52) U.S. Cl. 705/1

(57) ABSTRACT

A method and apparatus for analysing intellectual property information and generating a report is disclosed. A user input is received which comprises a user selection of one of a plurality of templates defining a plurality of predetermined intellectual property analyses, or user selections of a plurality of predetermined intellectual property analyses. Intellectual property data is retrieved from at least one database in dependence upon intellectual property data required for the selected intellectual property analyses. The predetermined intellectual property analyses are performed on the retrieved intellectual property data to generate a plurality of sets of analysed data. A partial intellectual property analysis report is generated displaying said sets of analysed intellectual property data as graphics. Intellectual property interpretation data is received from an interpreter giving the interpreter's interpretation of at least one of the displayed set of analysed intellectual property data. The intellectual property interpretation data for the at least one displayed set of analysed intellectual property data is included in the partial intellectual property analysis report to generate the complete intellectual property analysis report.

### FIELD OF THE INVENTION

The present invention relates to the analysis of intellectual property information and the provision of reports. In particular the present invention relates to method and apparatus for analysing intellectual property information and generating a report and also to an intellectual property analysis service for analysing intellectual property information and providing a report to a customer.

### BACKGROUND OF THE INVENTION

Intellectual property (IP), namely trade marks, designs, copyrights and patents is an important asset of any company and knowledge about a company's own IP assets as well a its competitors IP is important. IP information can include a vast amount of technological information, legal information, economic information and strategic business information. Analysis of a company's or industry's IP can allow a company to make strategic decisions about their own IP′ product development and commercial opportunities. IP information is available from many sources and can be downloaded over the internet from many different databases. Some sources are available free of charge, others charge by usage and others require subscription. Each source of IP information provides its own user interface and provides results in its own proprietary format. IP searching requires training in order to carry out efficient and accurate searches and such searches only provide the search results as raw data.

There are many IP analysis tools available on the market for analysing IP and generating graphic representations of IP for companies or technical fields. Such analysis tools includes Derwent Analytics (powered by Vantage Point )™ available from Thomson Corporation and Aureka™ (formerly Aurigin) available from Thomson Corporation. The analysis tools overcome the problem of how to usefully utilise search results and enable search results to be analysed to provide graphical representations of the IP data. However, operators still require significant training in order to operate the analysis software. Also, each analysis tool performs certain types of analysis forcing users to require multiple analysis software tools for the performance of a wide variety of analyses. Further, the analysis software is fully automated and it is thus unable to take into account inconsistencies in the IP information, such as the use of multiple name styles for the same company. In addition, these existing tools cannot be customised to a customer's specific requirements, such as the modification of charts or metrics used in the analysis, and do not include expert commentary on the key trends.

US2002/0138465 discloses a system and method for searching for and organising IP information in which a user can customise reports. A user can create and store templates for population during report generation. This is however a system for automated generation of a report without significant expert human analysis input and thus it is limited by the rigidity of the data being processed.

US2004/0083422 discloses a system and method for automatically generating patent analysis reports. The system and method downloads and stores patent data based on user set download and analysis conditions. A user then selects a patent analysis report template, analysis types and display formats and a report is then automatically generated for the user. Once again, this system does not provide for significant human analysis input and it is thus limited by the rigidity of the data being processed.

### SUMMARY OF THE INVENTION

The present invention is applicable to all aspects of intellectual property, namely trade marks, designs, copyrights and patents.

A first aspect of the present invention provides a method and apparatus for generating an intellectual property analysis report, in which a user input is received comprising, one of: a user selection of one of a plurality of templates defining a plurality of predetermined intellectual property analyses, and user selections of a plurality of predetermined intellectual property analyses; intellectual property data is retrieved from at least one database; said predetermined intellectual property analyses is performed on said retrieved intellectual property data to generate a plurality of sets of analysed data; a partial intellectual property analysis report is generated displaying said sets of analysed intellectual property data as graphics; intellectual property interpretation data giving an interpreter's interpretation of at least one said displayed set of analysed intellectual property data is received; and said intellectual property interpretation data for said at least one displayed set of analysed intellectual property data is included in said partial intellectual property analysis report to generate said intellectual property analysis report.

This aspect of the present invention can be incorporated in the provision of an intellectual property analysis service to a customer by the generation of the intellectual property report and the provision of the report to a customer.

Thus, in this aspect of the present invention, an expert human and/or machine assisted interpretation of one or a number of the displayed set of intellectual property data is input by an interpreter to provide a report which is enriched compared to an automatically generated report to complement the associated patent bibliographic data. The interpretation can comment on trends in the data and can import knowledge external to the data, such as company knowledge or technology knowledge, in the interpretation of the data.

In all aspects of the present invention, graphics can comprise any pictorial form of data presentation such as tables, spreadsheets, graphical text, graphs, maps, scatter plots, or charts such as bar charts, pie charts or spider charts.

In one embodiment, a user can select of one of a plurality of a graphic types for at least one said graphic for use in the generation of said partial intellectual property analysis report. The graphic types can for example be a table, a graph, a map, a pie chart etc.

In one embodiment, a user can input a modifying user input to modify the appearance of at least one graphic after the generation of the partial intellectual property analysis report, and the partial intellectual property analysis report is re generated in dependence upon the modifying user input.

In one embodiment, a user can input a modifying user input to define a modified intellectual property analysis to be performed after the generation of the partial intellectual property analysis report, and the partial intellectual property analysis report is re generated in dependence upon the modifying user input.

In one embodiment, at least one said template includes standard text fields, and identifying text is input in said standard text fields for identifying the subject of at least sections of the intellectual property analysis report.

In one embodiment, said at least one template can provide for form based entry of said intellectual property interpretation data and includes at least one text box associated with at least one respective graphic.

In one embodiment, the retrieved intellectual property data is processed to cleanse the data before analysis.

In one embodiment, the retrieved intellectual property data is processed to add associations between data entries before analysis.

In one embodiment, the intellectual property report includes commercial, business and financial information to enhance the intellectual property data.

In one embodiment, the analysed intellectual property data used in the generated intellectual property report can be provided to the customer with the report to enable the customer to carry out their own further analysis of the data based on the information given in the report.

In one embodiment, said received intellectual property interpretation data further comprises receiving summary intellectual property interpretation data summarising the intellectual property data in said report, and said summary intellectual property interpretation data is included in said partial intellectual property analysis report to generate said intellectual property analysis report.

Another aspect of the present invention provides a method and apparatus for generating an intellectual property analysis report, in which intellectual property data is received from at least one database; the retrieved intellectual property data is processed to cleanse the data and to add associations between data entries before analysis; a user selection of one of a plurality of templates defining a plurality of predetermined intellectual property analyses, or selecting a plurality of predetermined intellectual property analyses is received; said predetermined intellectual property analyses is performed on said processed intellectual property data to generate a plurality of sets of analysed data; and an intellectual property analysis report is generated including said sets of analysed intellectual property data as graphics.

This aspect of the present invention can be incorporated in the provision of an intellectual property analysis service to a customer by the generation of the intellectual property report and the provision of the report to a customer.

Thus, in this aspect of the present invention the quality of the intellectual report is enhanced by the processing of the intellectual property data to cleanse the data by, for example, removing disparate names used for the same legal entity, and to add associations between data entries by, for example, associating data entries for related companies.

Another aspect of the present invention provides a method and apparatus for generating an intellectual property report, in which a user selection of one of a plurality of templates defining a plurality of predetermined intellectual property analyses, or selecting a plurality of predetermined intellectual property analyses is received; intellectual property data is retrieved from at least one database in dependence upon intellectual property data required for the selected intellectual property analyses; said predetermined intellectual property analyses is performed on said retrieved intellectual property data to generate a plurality of sets of analysed data; an intellectual property analysis report is generated including said sets of analysed intellectual property data as graphics; a modifying user input is received to define a modified intellectual property analysis; and the intellectual property analysis report is re generated in dependence upon the modifying user input.

This aspect of the present invention can be incorporated in the provision of an intellectual property analysis service to a customer by the generation of the intellectual property report and the provision of the report to a customer.

Thus, in this aspect of the present invention the report is interactive allowing a user to amend the report after its initial generation so as to be able to include a modified analysis in the report. Thus, if a user does not think that a particular analysis provides a useful result for inclusion in the report, a new or modified analysis report can be used instead.

In one embodiment, a user can select one of a plurality of graphic types for at least one said graphic for use in the generation of said intellectual property report.

Another aspect of the present invention provides a method of providing an intellectual property analysis service to a customer, the method comprising: individually selecting a plurality of predetermined intellectual property analyses and/or a plurality of bespoke intellectual property analyses; retrieving intellectual property data from at least one database in dependence upon intellectual property data required for the selected intellectual property analyses; performing said predetermined intellectual property analyses on said retrieved intellectual property data to generate a plurality of sets of analysed data; generating an intellectual property analysis report including said sets of analysed intellectual property data as graphics; and providing said intellectual property report to said customer.

This aspect of the present invention provides a service for the provision of a bespoke intellectual property report for a customer by the individual selection of intellectual property analyses based upon a customer's business requirements.

In one embodiment, a selection is made to modify the appearance of at least one graphic after the generation of the intellectual property analysis report, and the intellectual property analysis report is re generated in dependence upon the modifying selection.

In one embodiment, a selection is made to define a modified intellectual property analysis to be performed after the generation of the intellectual property analysis report, and the intellectual property analysis report is re generated in dependence upon the modifying selection.

In one embodiment, the retrieved intellectual property data is cleansed before analysis.

Another aspect of the present invention provides a method and apparatus for generating an intellectual property analysis report, in which intellectual property data is retrieved from at least one database; the retrieved intellectual property data is reclassified; said predetermined intellectual property analyses is performed on said retrieved and reclassified intellectual property data to generate a plurality of sets of analysed data; and an intellectual property analysis report is generated including said sets of analysed intellectual property data as graphics.

This aspect of the present invention can be incorporated in the provision of an intellectual property analysis service to a customer by the generation of the intellectual property report and the provision of the report to a customer.

Thus, in this aspect of the present invention the report generated is more useful to a customer because of the use of reclassified data which has been classified into classifications of relevance to the user, for example classifications which are: product dependant, dependant upon corporate structure, or dependant upon a small group of technical field categories.

Another aspect of the present invention provides a method and apparatus for generating an intellectual property analysis report, in which a user input is received defining a report to be generated; first intellectual property data is received from at least one database in dependence upon intellectual property data required for the report; second intellectual property data cited in and/or citing the retrieved intellectual property data is identified; said second intellectual property data is retrieved from at least one database; the second intellectual property data is associated as citation intellectual property data for said first intellectual property data; said first and second intellectual property data is analysed to generate analysed intellectual property data; and an intellectual property analysis report is generated displaying said analysed intellectual property data as graphics.

This aspect of the present invention can be incorporated in the provision of an intellectual property analysis service to a customer by the generation of the intellectual property report and the provision of the report to a customer.

Thus, in this aspect of the present invention provides for the generation of a report including citation information by building citation associations in the data.

Another aspect of the present invention provides a method and apparatus for citation analysis for intellectual property for a customer, in which data for intellectual property owned by a customer is retrieved from at least one database; data for citation intellectual property cited in and/or citing the retrieved intellectual property is retrieved from at least one database, the data including information on the owner of said citation intellectual property; and a semantic analysis of the intellectual property data for the citation intellectual property is performed to determine pertinent intellectual property in said citation intellectual property.

In this aspect of the present invention, the term semantic analysis is intended to encompass semantic analysis and natural language processing.

This aspect of the present invention is a useful tool in numerous business activities, which include for example IP audits, competitor analysis and infringement, merger and acquisition activities, due diligence, justification of patent threats and reviewing patent strategies over time.

This aspect of the present invention can be incorporated in the provision of a service to a customer for identifying potential licensees and/or licensors for intellectual property by generating a report of the identified owners of the pertinent intellectual property as potential licensees and/or licensors.

Thus, in this aspect of the present invention provides the ability to use the intellectual property analysis for the commercial purpose of identifying potential licensees and/or licensors.

Any of the aspects of the invention briefly described above can be used together in any combination.

The present invention encompasses the use of one or a number of networked computers and the use of one or a number of computer programs in order to implement the present invention. The present invention thus encompasses any suitable carrier medium carrying computer readable code for controlling one or a number of computers to carry out the method. The carrier medium can be any suitable carrier medium, such as a signal e.g. an electronic, electrical, optical, microwave, magnetic, electromagnetic, acoustic, or electro-optical signal (including the specific example of a TCP/IP signal carried over a network), or a storage medium such as a floppy disk, optical memory devices and disks (such as Compact Disk (CD) or Digital Versatile Disk (DVD)), magnetic media such as tapes and disks, and solid state memory devices.

### BRIEF DESCRIPTION OF THE DRAWINGS

FIG. 1 is a schematic diagram of a system in accordance with one embodiment of the present invention.

FIG. 2 is a flow diagram showing the process for the IP data searching and processing in accordance with one embodiment of the present invention.

FIG. 3 is a flow diagram showing the process for the generation of an intellectual property report in accordance with one embodiment of the present invention.

FIG. 4 is a schematic diagram of the whole process involved in obtaining the data for and generating a patent report in accordance with one embodiment of the present invention.

FIG. 5 is a schematic diagram of the data structure formed for retrieved patent data in accordance with one embodiment of the present invention.

FIG. 6A and 6B are an illustration of the details of the patent data stored in the database for use in the generation of a patent report in accordance with one embodiment of the present invention.

FIG. 7 is a schematic illustration of a template used for a page of an intellectual property report in accordance with one embodiment of the present invention.

FIG. 8 is a diagram of a graphic for inclusion in a patent report showing published patents over time for a patent owner.

FIG. 9 is a diagram of a graphic for inclusion in a report showing patents in different geographical regions for a patent owner.

FIG. 10 is diagram of a graphic for inclusion in a report showing the range of expiration dates of US patents for a patent owner.

FIG. 11 is diagram of a graphic for inclusion in a report showing the number of patents created by inventors for patents owned by a company.

FIG. 12 is diagram of a graphic for inclusion in a report showing the number of patents in a top few US patent classes for a patent owner.

FIG. 13 is diagram of a graphic for inclusion in a report showing the number of patents in a top few International patent classifications for a patent owner.

FIG. 14 is diagram of a graphic for inclusion in a report showing representative International patent classifications associated with each technology category assigned to the patents in the reclassification process.

FIG. 15 is diagram of a graphic for inclusion in a report showing the technology breakdown of each of a plurality of companies' patent portfolio using the technology classifications assigned to the patents in the reclassification process.

FIG. 16 is diagram of a graphic for inclusion in a report showing a competitive landscape analysis over time for a company's patent portfolio.

FIG. 17 is diagram of a graphic for inclusion in a report showing a capitalization on innovation by incorporating technology categories for a company's patent portfolio.

### DETAILED DESCRIPTION OF PREFERRED EMBODIMENTS

The present invention provides a system which is particularly, although not exclusively, applicable as an internal system for IP intelligence report generation service in response to customer requirements. The system enables the service provider to integrate analysis tools and human interpretation input i.e. to integrate automated and human steps. IP specialists carry out the manual steps. The service provision allows the reports to be tailored to the requirements of the customer.

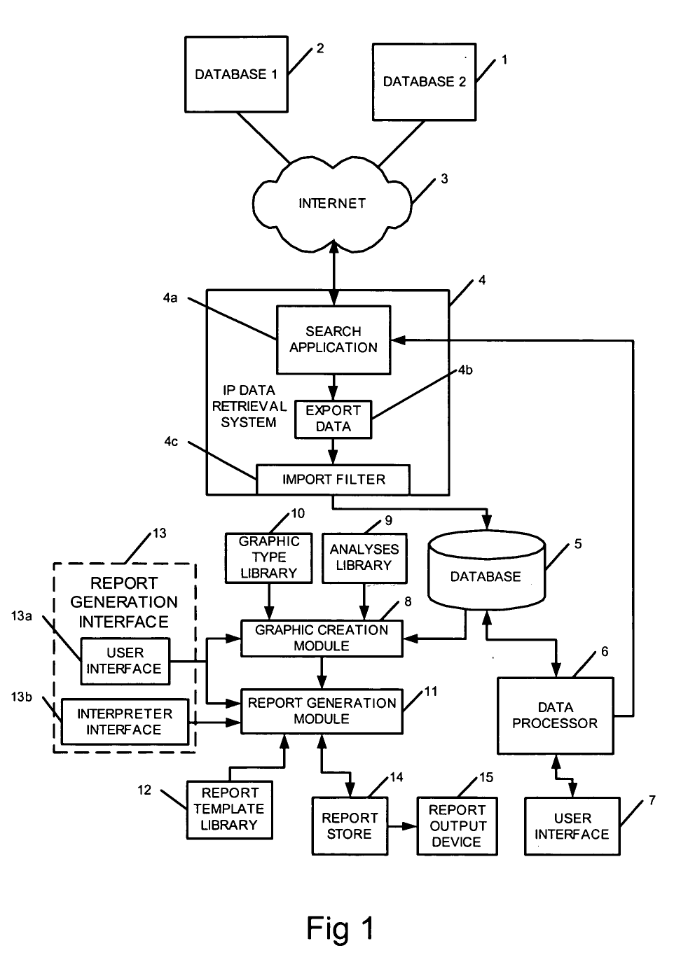

The architecture of a system for use in the provision of an IP report generation service will now be described with reference to FIG. 1.

Databases 1 and 2 comprise disparate databases of IP information, which are accessible over the internet 3. The databases can be free public resources or subscription based databases for example and the data held by these databases can be in very different formats. An IP data retrieval system 4 is connected to the internet to access the databases 1 and 2 to retrieve IP data for analysis to generate an IP report. The IP data retrieval system 4 comprises a search application 4a, which enables an operator to define search parameters and to send defined searches to the databases 1 and 2. Such search applications are well known in the art. Interfaced to the search application there is provided an application 4b to export the retrieved IP data in for example an XML (extensible mark-up language) format, tagged format, free text format or CSV format. An import filter 4c is provided to filter the data for input to a database 5. The filtering performed performs a low level cleaning of the data by for example removing duplicate data fields, and stripping out new lines and control codes before the IP data is loaded into the database 5.

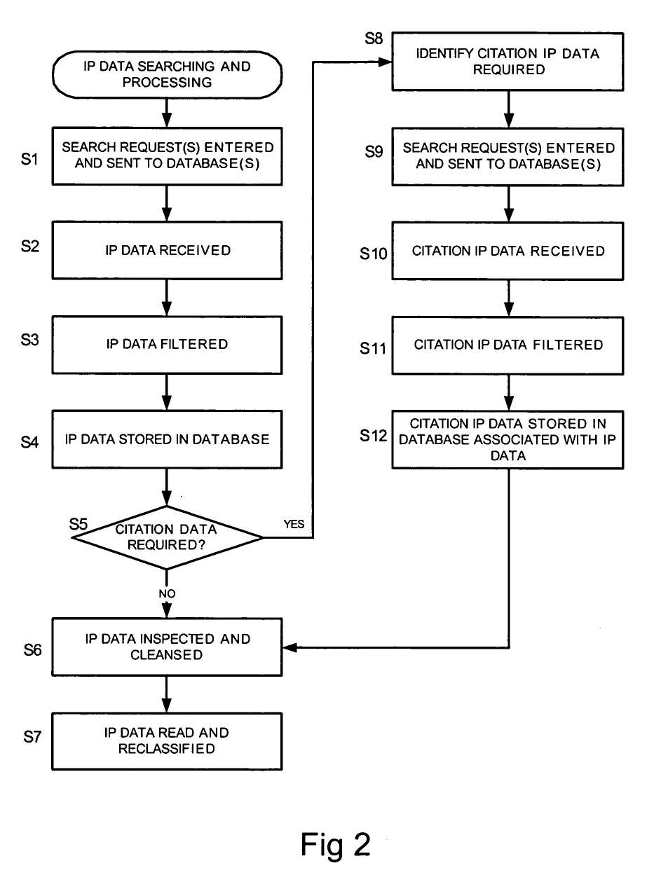

A data processor 6 is provided connected to the database 5 to access the IP data stored therein to process it in various ways. The data processor 6 is provided with a user interface 7. In this way a user can use the processor 6 to access the IP data to cleanse the data, generate associations between IP data entries and generally perform any operation on the data to make it ready for use in the generation of an IP report. The data processor 5 can process the IP data to identify citations for citation retrieval as will be described in more detail hereinafter. It can also associate IP data with common parameters such as IP families (e.g. patent families). The process of IP data retrieval and processing will be described in more detail hereinafter with reference to FIG. 2.

Although in this embodiment, the database 5 is created by accessing the data at remote databases 1 and 2, the present invention is not limited to the creation of a new database from data at other databases. The present invention encompasses the use of a single original database from which all the IP data required for the IP report generation is already available.

The components of the system for the generation of an IP report using the IP data in the database will now be described. The components for a ‘workbench’ for use by one or a number of users in the generation of an IP report.

A report generation interface 13 allows a user to use a user interface 13a to access a graphic creation module 8. The graphic creation module 8 is connected to the database 5 to retrieve all the IP data required for graphic creation. An analyses library 9 containing a library of analyses algorithms for the different analysis of the IP data in the generation of a graphic for the IP report is provided connected to the graphic creation module 8. A graphic type library 10 containing a library of different graphic type such as a bar chart, a pie chart, a table, a graph, etc is provided connected to the graphic creation module 8. A report generation module 11 is provided to generate IP reports and it is connected to the graphic generation module 8 to access graphics generated by the graphic creation module 8 for inclusion in the IP report. A report template library 12 containing predetermined templates for use in the generation of IP reports is provided connected to the report generation module 11. A report store 14 is connected to the report generation module 11 for storing IP reports during the generation of the report and when finalised. The reports can be output using a report generation device 15. The device 15 can be any output device such as a printer, a display, or a transmission device such as an electronic interface e.g. email or a web page in which the IP report is output electronically. The device 15 can even comprise a memory device such as a floppy disk, CD ROM, or solid-state memory device wherein the IP report is output on the memory device.

The report generation interface 13 also included an interpreter's interface 13b connected to the report generation module 11 to enable a human interpreter to input interpretation data into the report for graphics and as a summary for the report.

The hardware and software environment to implement the system of FIG. 1 can comprise any conventional well known hardware and software environments as would be well known to a skilled person. The software used for the ‘workbench’ includes any well known IP analysis tools such as Vantage Point™ or Aureka™ which can provide for the generation of the graphics. The ‘workbench’ can also include custom in-house development software to generate the required analyses and graphics. The report generation module 11 can provide a web or form based interface to allow the interpreter to input the interpretation text in a text window in the report. It also allows a user to modify the graphs or select new or modified graphs in the report.

The process of IP data retrieval and processing will now be described with reference to FIG. 2.

In step S1 a user uses the search application 4a to define and send a search to the databases 1 and 2. IP data is then received from the databases 1 and 2 (step S2). The IP data is filtered (step S3) by the import filter 4c to perform a low-level data cleansing and the IP data is then stored in the database 5 (step S4). At this point, it is determined whether the IP report requires citation IP data i.e. IP data cited in the retrieved IP data records (step S5). If not, in step S6 the IP data undergoes processing by the data processor 6 to cleanse the data and to add associations. A user, using the user interface 7, can perform the cleansing manually. This can include:
a) error data correction,
b) field formatting for combination of data from multiple data sources
c) correct casings in the data,
d) name unification to combine different name representations for the same legal entity—for example, ABC Corporation, ABC Corp, and A.B.C Corp are the same legal entity and the company name in the IP data will be unified. This process can be machine assisted e.g. by a fuzzy logic matching process, regular expression, thesauri or ontology based.
e) family creation—where IP assets are related, they are associated e.g. a patent family of patents having the same priority date
f) subsidiary based or merger and acquisition (M&A) activity based—for example Pfizer owns IP which used to belong to Pharmacia who they purchased.
g) Association based—for example associating a particular attorney to the firm or corporation for which he/she is employed.

The associations to be added can include the parsing of the data to create new elements including:
a) attorney
b) assignee
c) inventors
d) expiry dates
e) IP type e.g. patent, patent application, or design,

For this process, the fuzzy logic matching process can be used.

Further associations can be generated for known related legal entities such as related or subsidiary companies.

In step S7, a user can use the user interface 7 to optionally access the IP data and reclassify it in accordance with a limited number of classifications which are of some relevance to the customer of the IP report. For example, reclassification can be based on:
a) corporate structure—a company may have different divisions or subsidiaries in different technical fields
b) profit centres—a company may have separate profit centres i.e. sections of the business for which separate accounts are kept
c) products
d) single business units—a company may be formed of many business units such as related companies
e) research and development centres
f) departments
g) groupings of IPC, ECLA, F-term or USC codes or any other classification system

The reclassification requires a user to use the current classification data for the IP data and to add a new classification in one of the limited number of classifications. For patents, the classifications can be technical classifications. The number of classifications typically is between 4 and 6, although any number required by the customer can be used.

The reclassification process can involve manual, automatic and semi-automatic processes. An automated reclassification can use a data mining tool to group sets of data together based on thesauri, key words or phrases, and/or natural language processing of data fields. Manual processes includes an expert review of the claim language, patent to product mapping, and mapping of technology classification to application or use of the patented invention. Semi-automated processes include a technical expert review of clusters or predefined groups of patents, applying customer knowledge to pre-defined lists of classification codes, key terms, etc, and applying corporate structure such as department names to category titles to show a representation of the patent portfolio as it relates to the perception of the customer.

If in step S5 it is determined that citation IP data is required for the IP report generation, the required citation IP data is identified by the data processor 6 (step S8). The citation data can include both forward and backward citations i.e. the IP data cited in the retrieved IP data and other IP data, which cites the retrieved IP data. A search request is thus made by the search application 4a to the databases 1 and 2 for the citation IP data (step S9). The search request can be for the citation IP data cited in the retrieved IP data and for citation IP data that cites the received IP data. The citation IP data is received by the search application 4a (step S10) and it is filtered by the import filter 4c (step S11) before being stored in the database 5 in association with the IP data (step S12). The association associates the citation IP data to the IP data and indicates the direction of citation. The process then moves to step S6 for the cleansing of the IP data and the associated citation IP data before the IP data and the associated citation IP data is reclassified in step S7.

Thus in this way ‘value added’ and commercially relevant IP data is created based on human interpretation.

In the flow chart of FIG. 2, the steps of data cleansing and reclassification are optional. The level of cleansing and reclassification can be selected by the user.

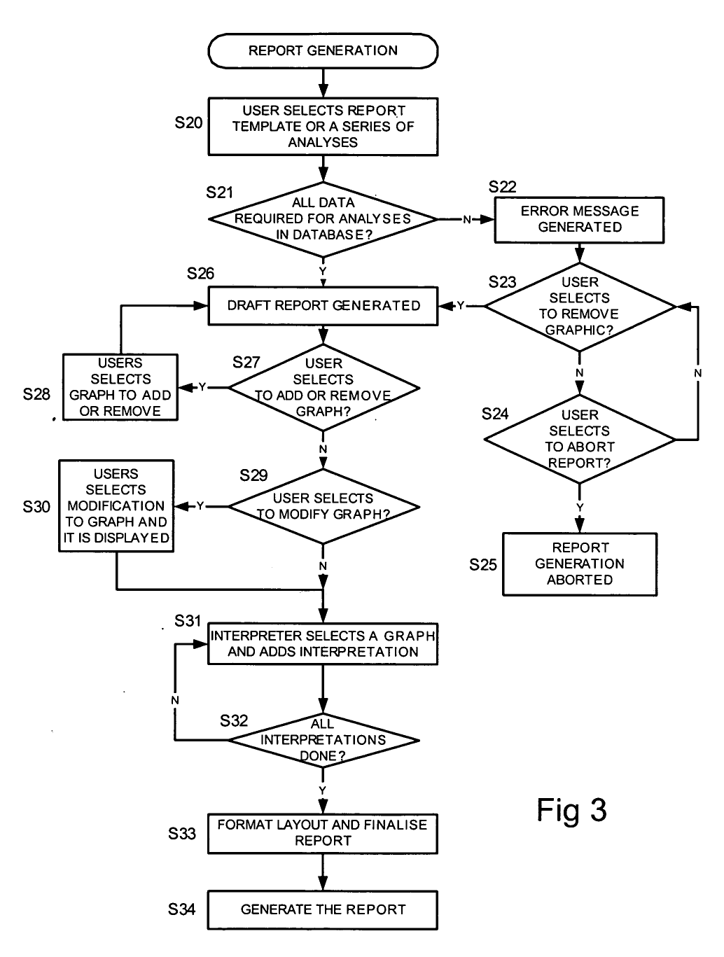

The process of IP report generation will now be described with reference to the flow diagram of FIG. 3.

In step S20 a user of the user interface 13a selects a report template or a series of analyses from the report template library 12 for the formation of the IP report. A template will predefine a plurality of analyses to be performed on the IP data in the database 5 and it will define default graphic types for the graphics to display the result of the analyses. The graphic creation module 8 will then perform the analyses using the analyses library 9 and the graphic type library 10. If IP data necessary for the analyses is not present in the database 5 (step S21), and error message is generated to ward the user (step S22). The user can then select to remove the graphic or graphics for which there is insufficient data from the IP report (step S23), in which case a draft IP report will be generated (step S26), or the user can select to abort the report generation (step S24), in which case the IP report is aborted (step S25).

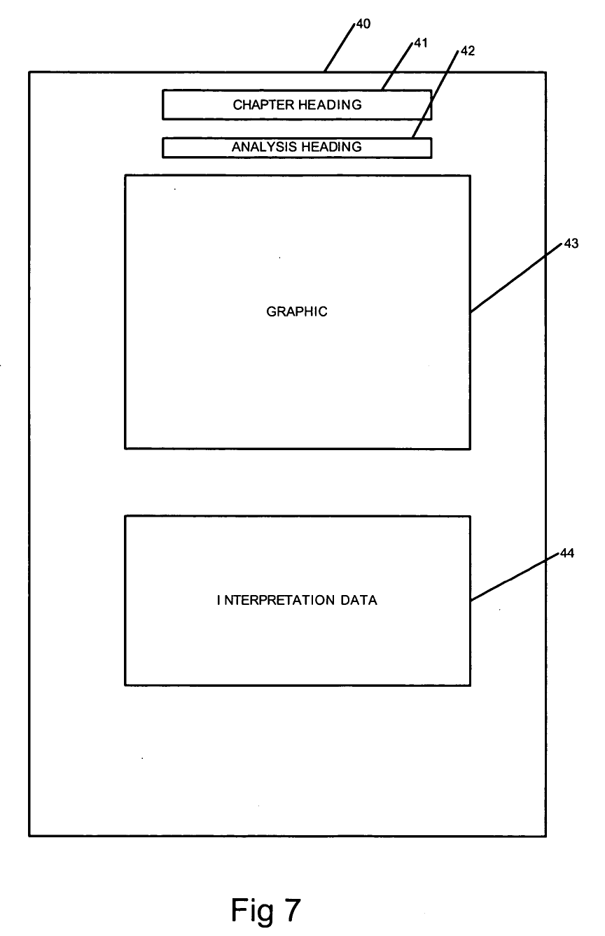

The draft IP report generated so far will include the graphics of the predefined template (or the selected graphics) and some predefined text. The predefined text can either be predefined in the template, and/or it can be entered before the report generation process by the user. An example partial template 40r one page of the report is illustrated in FIG. 7. The template defines an analysis to be performed, a graphic type and a region 43 a report page in which the graphic is to appear. Predefined text such as a heading for the page and the analysis heading are defined in text boxes 41 and 42. A text box 44 is also defined for the input of interpretation data by an interpreter for the graphic 43, as will be described in m ore detail hereinafter.

The user using the user interface 13a is able to modify the draft report in several ways to tailor the report and provide a bespoke IP report. The user can select to add or remove graphics i.e. pages in the IP report (step S27) and then select the graphic to be added or removed and hence the analysis to be carried out or removed (step S28). The draft report is regenerated after each addition (step S26). The user can also select to modify a graphic (step S29). The user can modify the graphic by selecting to change the graphic type based on the types of graphics available in the graphic type library 10 e.g. change the graphic from a pie chart to a bar chart. No new analysis is performed on the IP data. It is simply redisplayed in a different graphic type on the report page. The user can also modify display parameters for the graphics such as scaling, colours, font type and size etc.

An interpreter can use the interpreter's interface 13b to access the draft report and to add interpretation text to the report (step S31). The interpreter can be an IP expert or technology expert who reviews each graphic and uses their knowledge to interpret the graphic so as to be able to make a contribution to the information conveyed by the IP report. The interpreter adds the interpretation data as text in the text box 44 under each graphic in the IP report using a form based input, whereby the interpreter simply selects the text box and enters the text. The interpreter can also add a summary interpretation at the end of the IP report to give an overall summary interpretation of the IP information contained in the IP report.

Once all of the interpretations have been entered in the draft IP report (step S32), the user can perform a final format layout and finalise the IP report (step S33). The report is then generated (step S34). The report can be generated in any known electronic form, such as a word processor document, or an image document such as a PDF document.

The report can include business and financial information which can either be input by the interpreter manually, or can be obtained from data sources automatically and inserted into the report. The report can thus be enhanced with this information.

In addition to the provision of the report to the customer, the analysed data used in the report can be provided to the customer in electronic form e.g. as a spreadsheet to enable the customer to perform their own further analysis on the data based on the information given in the report.

There are many different types of reports that a customer may wish to commission to address specific business needs. The templates provide for a number of standard reports such as a brief report on a company's IP, a detailed report on a company's IP with a more in depth commentary, a brief report on a technology sector showing other companies' IP, and a detailed report on a technology sector showing other companies' IP with a more in depth commentary. The IP report can be a static report or a dynamic report with mark-up links within to allow a customer to access more detail by following links in the report. Also reports can be generated to show IP being handled by professional representatives. A report can also be generated to identify licensing opportunities, whereby the citation data is used in the graphics to illustrate where potential licensees IP has been cited against the customer's IP. The fact that the IP has been cited means that the IP owner is working in the same field and may thus be interested in licensing the customers IP.

For a company report the report can include analysis of IP for authors, geographical origin of IP, IP over time, attorneys, classification or subject area and competitor's IP information.

Although in the above description of IP report generation, a user and an interpreter are described, they can be the same person. Also the interpreter need not be at the same location or be from the same organisation as the user performing the report generations. In this way the interpretation can be outsourced to appropriate experts. Further, the interpretation data can be manually generated or it can be generated with machine assistance.

A more specific non-limiting embodiment of the present invention will now be described in relation to patent report generation.

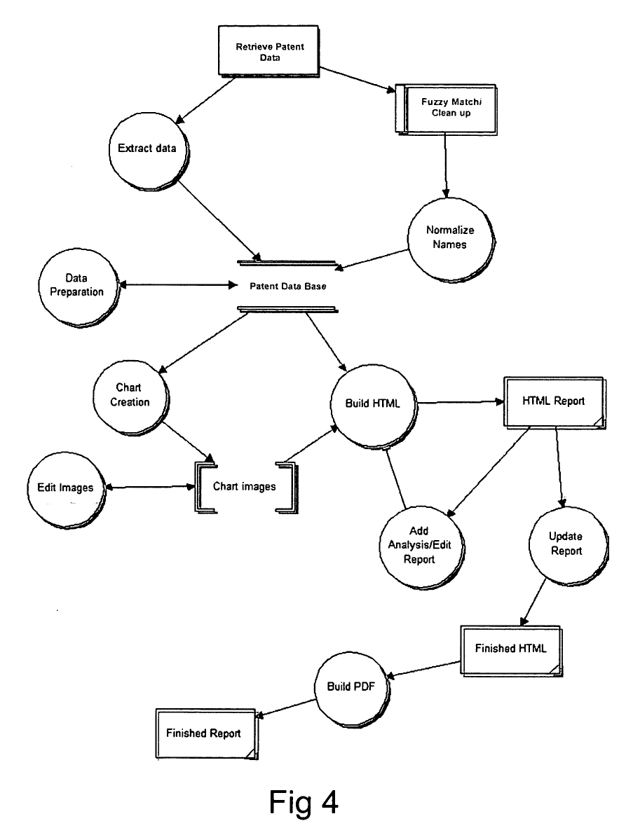

FIG. 4 illustrates the whole process of data preparation and report generation process for the generation of a patent report. Patent data is retrieved and the required data is extracted. A fuzzy matching process in combination with a manual process is used to match and clean up the names of the patent owners. Data preparation is performed to cleanse the data, to add associations, and to perform reclassification. The chart images are generated and edited by the user and these are used to build the report. The report can be edited and analysis or interpretation data can be added. The report can be updated and finalised to generate a report which in this embodiment is formed in HTML (hyper text mark-up language) form. The HTML report is then converted to a Microsoft™ Word or PDF document and output as a finished report.

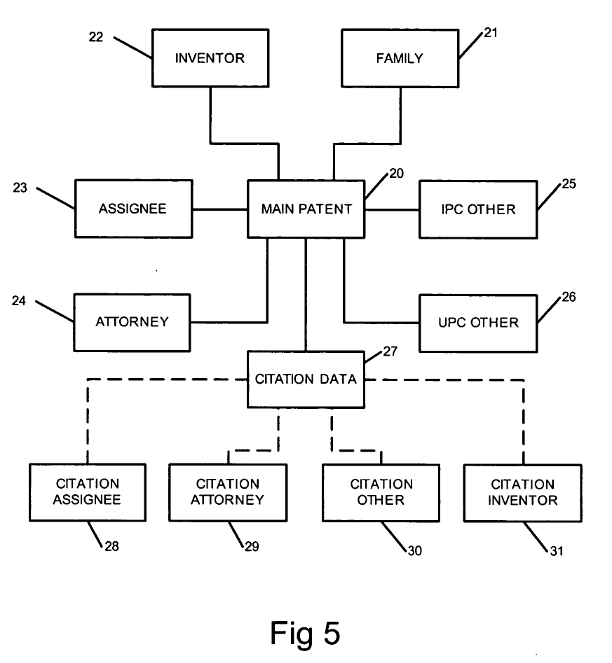

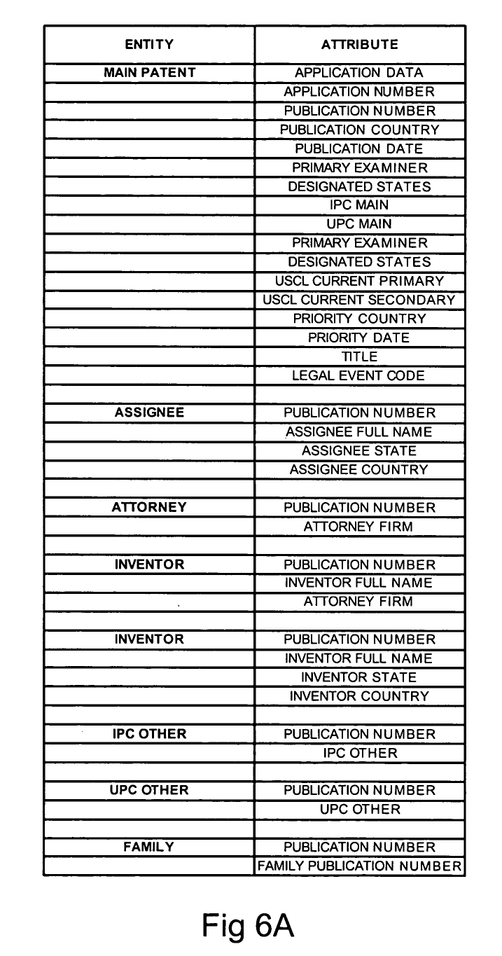

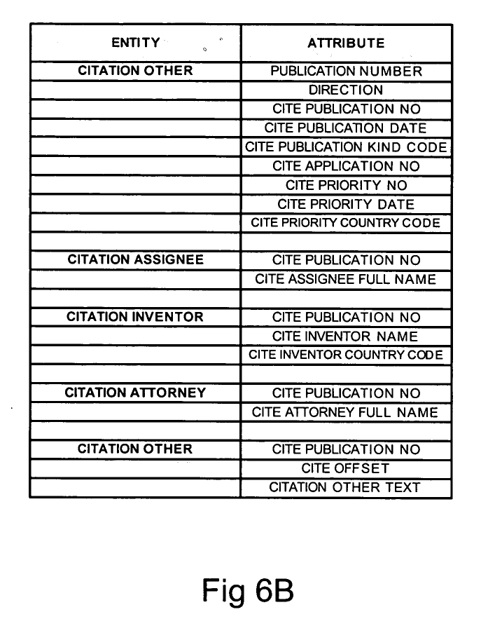

FIG. 5 is a diagram illustrating the data structure of the data stored in the database 5 in the specific embodiment of the present invention in which a patent report is generated. FIGS. 6A and 6B illustrate the data in more detail.

The main patent data 20 is linked in the database 5 to patent family data 21 identifying other patent records in the same patent family, inventor data 22 for the inventor or inventors, assignee data 23 identifying the assignee to whom the patent has been assigned, attorney data 24 identifying the responsible attorney, IPC and other data 25 identifying the IPC (International Patent Classification) in which the patent has been classified, the UPC data 26 identifies the US patent classification into which the patent has been classified, and the citation data 27 identifies data on patents that have been cited against the patent. The citation data 27 comprises citation assignee data 28 identifying the assignee to whom the cited patent has been assigned, citation attorney data 29 identifying the representative for the cited patent, citation inventor 31 identifying the inventor for the cited patent, and citation other data 30 identifying data such as the citation publication number, priority date, priority number, and application number.

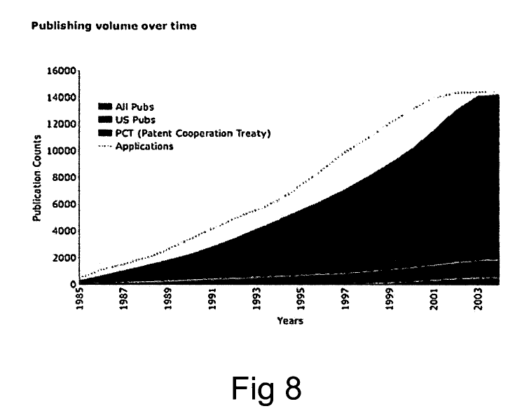

Example graphics generated for patent reports will now be described with reference to FIGS. 8 to 17. The graphics illustrated in FIGS. 8 to 17 are merely examples of the types of graphics that can be generated in accordance with the invention and the invention is not limited to the specific graphics shown.

FIG. 8 illustrates a graphic generated showing published patents over time for a company's patent portfolio. The graphic type is a graph and it shows an increase in patent filings over the years.

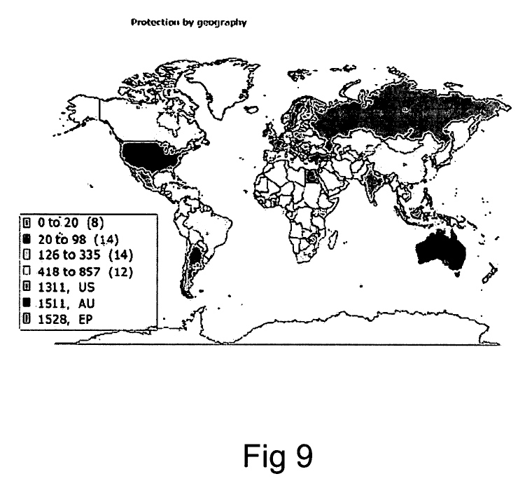

FIG. 9 illustrates a graphic generated for a company showing their patent portfolio geographically. The graphic type for this graphic is a map.

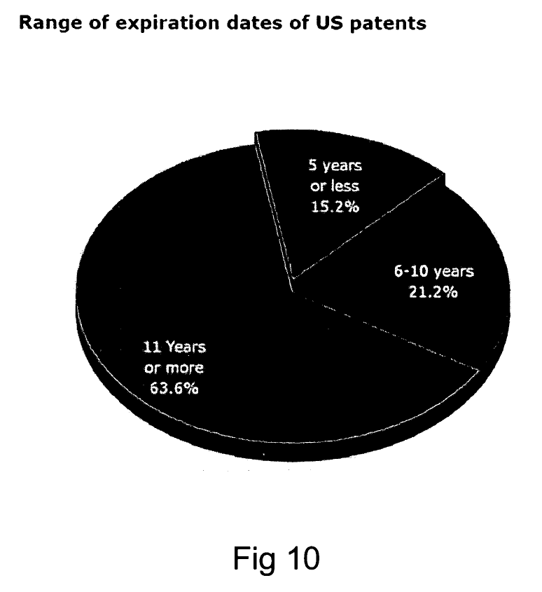

FIG. 10 illustrates a graphic generated for a company showing the range of expiry dates for their patent portfolio. The graphic type for this graphic is a pie chart.

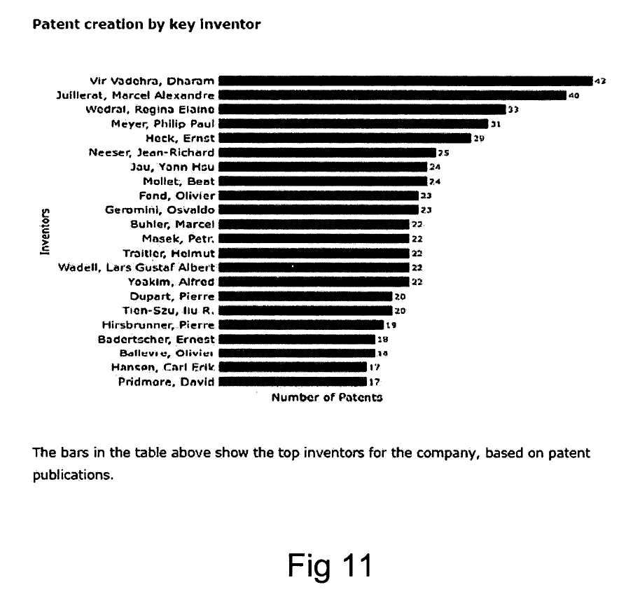

FIG. 11 illustrates a graphic generated for a company showing the number of patents originating from the top inventors in the company. The graphic type used for this graphic is a bar chart.

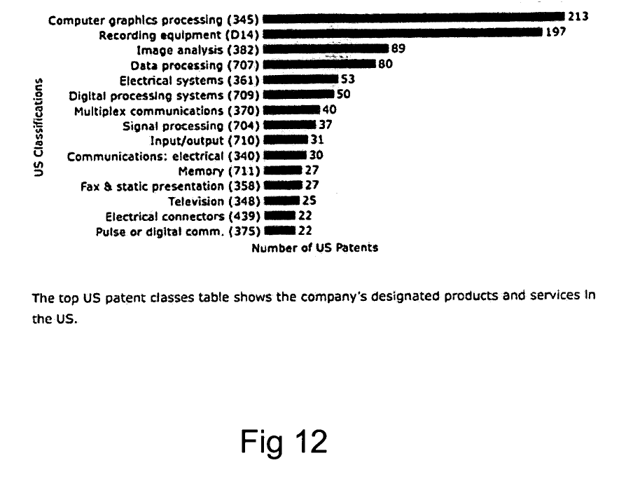

FIG. 12 illustrates a graphic generated for a company showing the top US patent classes for patents in the company's patent portfolio. The graphic type used for this graphic is a bar chart.

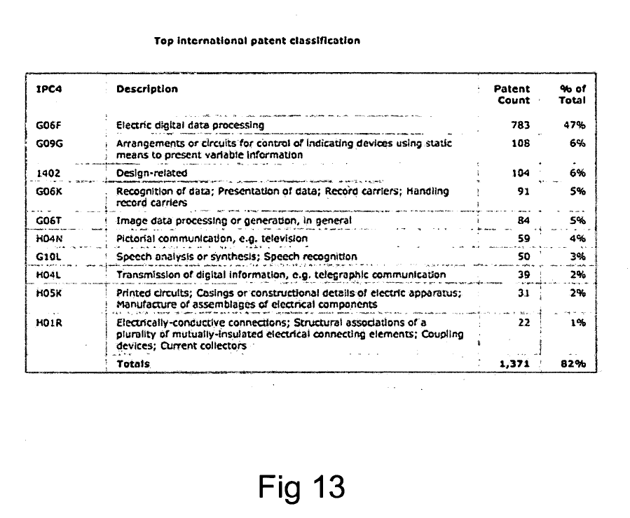

FIG. 13 illustrates a graphic generated for a company showing the top IPCs for patents in the company's patent portfolio. The graphic type used for this graphic is a table.

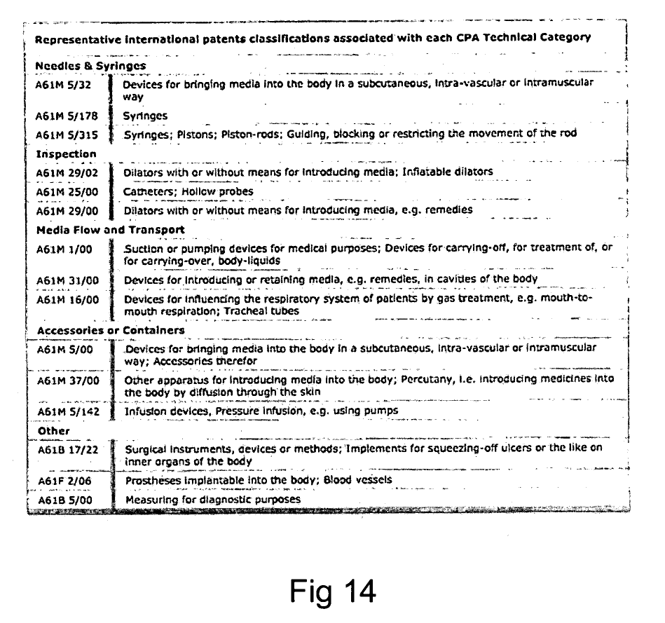

FIG. 14 illustrates a graphic generated to show the relationship between IPCs and the new technical classifications in 5 technical fields. The graphic type used for this graphic is a table.

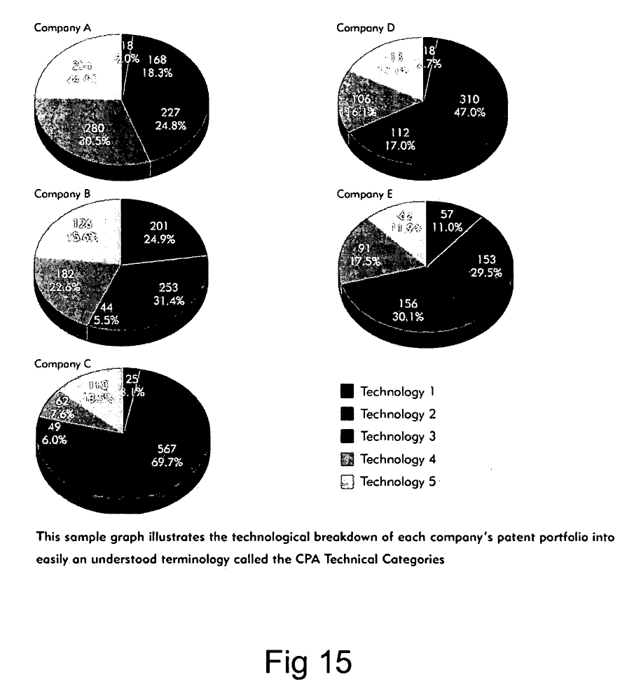

FIG. 15 illustrates a graphic generated to show the technological breakdown of each of a plurality of companies' patent portfolios into new technical categories. The graphic type used for this graphic is a pie chart.

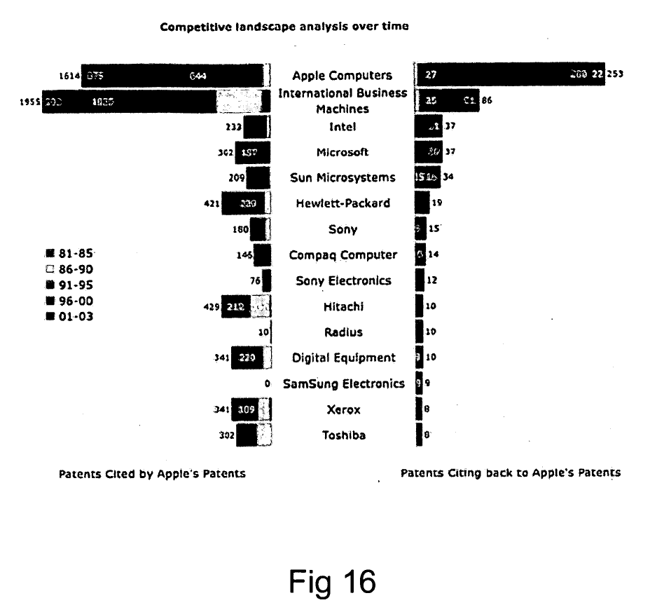

FIG. 16 illustrates a graphic generated to show a competitive landscape over time, based on a company's (Apple Computers Inc) patent portfolio. The competitive landscape analysis is based on the citation data. It shows forward and backward citations i.e. patents of competitors cited by Apple's patents and competitors patents citing Apple's patents. This can show useful information on relative competitor activities. It can indicate technical areas in which competitors are working. The customer can use this information to identify potential licensees for their patents. If a competitor is active in the field of a patent, as indicated by the citation data, if the customer wishes to find a licensee for the patent, they may wish to consider offering the competitor a licence to the patent. It could also be used as a tool to try to identify potential infringers of a patent in the same way. In addition, it can be used as a tool in the due diligence of the development of a new product before launch and in the justification of patent threats.

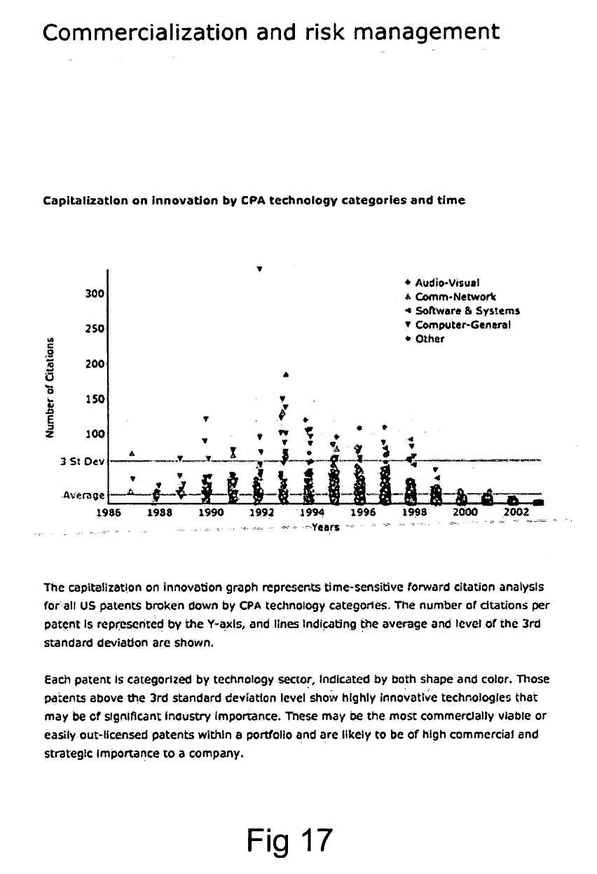

FIG. 17 illustrates a graphic generated to show capitalization on innovation by technology categories and time for a company's patent portfolio. The patent portfolio is classified according to 5 technical fields, namely ‘audio-visual’, ‘comms-network’, ‘software and systems’, ‘computer—general’ and ‘other’. The Y-axis represents the number of citations per patent. The citations are forward citations i.e. which cite the customers patents. The average and 3^{rd} standard deviation are shown against the Y-axis. Those patents appearing high on the Y-axis represent potential high value patents because they are the most likely patents to be licensed within the portfolio. In this embodiment the graphic includes standard text below it in a text box explaining the details of the graphic.

In another embodiment of the present invention, one of the processes performed on the retrieved IP data and citation IP data by the data processor 6 includes semantic processing or natural language processing (NLP) on the wording in the IP data e.g. patent claims for patents. Semantic processing is well known in the art and commercially available tools such as Autonomy™ or Enginium™ can be used. Semantic processing and NLP assists in the analysis of the IP so that the most relevant IP can be determined. The result of the semantic analysis or NLP in combination with citation analysis identifies IP, which is more likely to be of high relevance to a customer. A customer can use the results of the semantic or NLP analysis on the citation data for a variety of purposes. For example it can be used to identify potential licensees an/or licensors, for competitor analysis, etc.

Although the present invention has been described with reference to specific embodiments, it will be apparent to a skilled person in the art that modifications lie within the spirit and scope of the present invention.

What is claimed is:

1. A method of generating an intellectual property analysis report, the method comprising:
receiving a user input comprising, one of: a user selection of one of a plurality of templates defining a plurality of predetermined intellectual property analyses, and user selections of a plurality of predetermined intellectual property analyses;
retrieving intellectual property data from at least one database in dependence upon intellectual property data required for the selected intellectual property analyses;
performing said predetermined intellectual property analyses on said retrieved intellectual property data to generate a plurality of sets of analysed data;
generating a partial intellectual property analysis report displaying said sets of analysed intellectual property data as graphics; and
receiving intellectual property interpretation data giving an interpreter's interpretation of at least one said displayed set of analysed intellectual property data and including said intellectual property interpretation data for said at least one displayed set of analysed intellectual property data in said partial intellectual property analysis report to generate said intellectual property analysis report.

2. A method according to claim 1, including receiving a user selection of one of a plurality of a graphic types for at least one said graphic for use in the generation of said partial intellectual property analysis report.

3. A method according to claim 1, including receiving a modifying user input to modify the appearance of at least one graphic after the generation of the partial intellectual property analysis report, and re generating the partial intellectual property analysis report in dependence upon the modifying user input.

4. A method according to claim 1, including receiving a modifying user input to define a modified intellectual property analysis to be performed after the generation of the partial intellectual property analysis report, and re generating the partial intellectual property analysis report in dependence upon the modifying user input.

5. A method according to claim 1, wherein at least one said template includes standard text fields, the method including inputting identifying text in said standard text fields for identifying the subject of at least sections of the intellectual property analysis report.

6. A method according to claim 1, wherein said at least one template provides for form based entry of said intellectual property interpretation data and includes at least one text box associated with at least one respective graphic.

7. A method according to claim 1, including processing the retrieved intellectual property data to cleanse the data before analysis.

8. A method according to claim 1, including processing the retrieved intellectual property data to add associations between data entries before analysis.

9. A method according to claim 1, wherein said received intellectual property interpretation data further comprises receiving summary intellectual property interpretation data summarising the intellectual property data in said report, and including said summary intellectual property interpretation data in said partial intellectual property analysis report to generate said intellectual property analysis report.

10. A method according to claim 1, wherein said intellectual property analysis report includes commercial, business and financial information.

11. Apparatus for generating an intellectual property analysis report, the apparatus comprising:
a user input device for receiving a user input comprising, one of: a user selection of one of a plurality of templates defining a plurality of predetermined intellectual property analyses, and user selections of a plurality of predetermined intellectual property analyses;
a retrieval engine for retrieving intellectual property data from at least one database in dependence upon intellectual property data required for the selected intellectual property analyses;
an analysis engine for performing said predetermined intellectual property analyses on said retrieved intellectual property data to generate a plurality of sets of analysed data; and
a report generator for generating a partial intellectual property analysis report displaying said sets of analysed intellectual property data as graphics, wherein said report generator is adapted to receive intellectual property interpretation data giving an interpreter's interpretation of at least one displayed set of analysed intellectual property data and to include said intellectual property interpretation data for said at least one displayed set of analysed intellectual property data in said partial intellectual property analysis report to generate said intellectual property analysis report.

12. Apparatus according to claim 11, wherein said user input device is adapted to receive a user selection of one of a plurality of a graphic types for at least one said graphic for use in the generation of said partial intellectual property analysis report.

13. Apparatus according to claim 11, wherein said user input device is adapted to receive a modifying user input to modify the appearance of at least one graphic after the generation of the partial intellectual property analysis report, and said report generator is operative to re generate the partial intellectual property analysis report in dependence upon the modifying user input.

14. Apparatus according to claim 11, wherein said user input device is adapted to receive a modifying user input to define a modified intellectual property analysis to be performed after the generation of the partial intellectual property analysis report, and said report generator is operative to re generate the partial intellectual property analysis report in dependence upon the modifying user input.

15. Apparatus according to claim 11, wherein at least one said template includes standard text fields, wherein said user input device is operative to receive identifying text in said standard text fields for identifying the subject of at least sections of the intellectual property analysis report.

16. Apparatus according to claim 11, wherein said at least one selected template provides for form based entry of said intellectual property interpretation data and includes at least one text box associated with at least one respective graphic, and said user input device is adapted to allow a user to enter text in said at least one text box.

17. Apparatus according to claim 11, including a data cleansing processor for cleansing the retrieved intellectual property data before analysis.

18. Apparatus according to claim 11, including a data processor to add associations between data entries to the retrieved intellectual property data before analysis.

19. Apparatus according to claim 11, wherein said received intellectual property interpretation data further comprises receiving summary intellectual property interpretation data summarising the intellectual property data in said report, and said report generator is operative to include said summary intellectual property interpretation data in said partial intellectual property analysis report to generate said intellectual property analysis report.

20. Apparatus according to claim 11, wherein said intellectual property analysis report includes commercial, business and financial information.

21. Apparatus for generating an intellectual property analysis report, the apparatus comprising:
receiving means for receiving a user input comprising, one of: a user selection of one of a plurality of templates defining a plurality of predetermined intellectual property analyses, and user selections of a plurality of predetermined intellectual property analyses;
retrieving means for retrieving intellectual property data from at least one database in dependence upon intellectual property data required for the selected intellectual property analyses;
analysing means for performing said predetermined intellectual property analyses on said retrieved intellectual property data to generate a plurality of sets of analysed data;
generating means for generating a partial intellectual property interpretation report displaying said sets of analysed intellectual property data as graphics, wherein said generator means is adapted to receive intellectual property interpretation data giving an interpreter's interpretation of at least one displayed set of analysed intellectual property data and to include said intellectual property interpretation data for said at least one displayed set of analysed intellectual property data in said partial intellectual property analysis report to generate said intellectual property analysis report.

22. Apparatus according to claim 21, wherein said receiving means is adapted to receive a user selection of one of a plurality of a graphic types for at least one said graphic for use in the generation of said partial intellectual property analysis report.

23. Apparatus according to claim 21, wherein said receiving means is adapted to receive a modifying user input to modify the appearance of at least one graphic after the generation of the partial intellectual property analysis report, and said reporting means is adapted to re generate the partial intellectual property analysis report in dependence upon the modifying user input.

24. Apparatus according to claim 21, wherein said receiving means is adapted to receive a modifying user input to define a modified intellectual property analysis to be performed after the generation of the partial intellectual property analysis report, and said reporting means is adapted to re generate the partial intellectual property analysis report in dependence upon the modifying user input.

25. Apparatus according to claim 21, wherein at least one said template includes standard text fields, wherein said receiving means is adapted to receive identifying text in said standard text fields for identifying the subject of at least sections of the intellectual property analysis report.

26. Apparatus according to claim 21, wherein said at least one selected template provides for form based entry of said intellectual property interpretation data and includes at least one text box associated with at least one respective graphic, and said receiving means is adapted to allow a user to enter text in said at least one text box.

27. Apparatus according to claim 21, including data cleansing means for cleansing the retrieved intellectual property data before analysis.

28. Apparatus according to claim 21, including data processing means to add associations between data entries to the retrieved intellectual property data before analysis.

29. Apparatus according to claim 21, wherein said received intellectual property interpretation data further comprises receiving summary intellectual property interpretation data summarising the intellectual property data in said report, and said generating means is adapted to include said summary intellectual property interpretation data in said partial intellectual property analysis report to generate said intellectual property analysis report.

30. Apparatus according to claim 21, wherein said intellectual property analysis report includes commercial, business and financial information.

31. A method of providing an intellectual property analysis service to a customer, the method comprising:
selecting one of a plurality of templates defining a plurality of predetermined intellectual property analyses, or selecting a plurality of predetermined intellectual property analyses;
retrieving intellectual property data from at least one database in dependence upon intellectual property data required for the selected intellectual property analyses;
performing said predetermined intellectual property analyses on said retrieved intellectual property data to generate a plurality of sets of analysed data;
generating a partial intellectual property analysis report displaying said sets of analysed intellectual property data as graphics;
performing an interpretation of at least one of said graphics by an interpreter;
including intellectual property interpretation data resulting from said interpretation of said at least one graphic in said partial intellectual property analysis report to generate an intellectual property analysis report; and
providing said intellectual property report to said customer.

32. A method according to claim 31, wherein said retrieval of intellectual property data includes performing a manual search in at least one database for said intellectual property data.

33. A method according to claim 31, including cleansing the retrieved intellectual property data to unify the data format before analysis.

34. A method according to claim 33, wherein said data cleansing includes unifying disparate entity names used for the same entities.

35. A method according to claim 31, including processing the retrieved intellectual property data to add association data representing associations between data entries.

36. A method according to claim 35, wherein said processing includes adding corporation associations for corporation fields in the data entries to associate subsidiary companies with their parent companies to allow the related companies to be processed as a single entity.

37. A method according to claim 35, wherein said processing includes adding entity associations for entity fields in the data entries to associate entities to allow the associated entities to be processed in combination.

38. A method according to claim 31, including selecting one of plurality of a graphic types for at least one said graphic for use in the generation of said partial intellectual property analysis report.

39. A method according to claim 31, including modifying the appearance of at least one graphic after the generation of the partial intellectual property analysis report, and re generating the partial intellectual property analysis report in dependence upon the modifying user input.

40. A method according to claim 31, including inputting identifying text in standard text fields for identifying the subject of at least sections of the intellectual property analysis report.

41. A method according to claim 31, wherein said intellectual property interpretation data is entered by an interpreter on a form based interface for inclusion in said intellectual property analysis report.

42. A method according to claim 31, wherein said intellectual property analysis report includes commercial, business and financial information.

43. A method according to claim 31, including providing said plurality of sets of analysed data to said customer.

44. A method of providing an intellectual property analysis service to a customer, the method comprising:
selecting one of a plurality of templates defining a plurality of predetermined intellectual property analyses, or selecting a plurality of predetermined intellectual property analyses;
performing said predetermined intellectual property analyses on intellectual property data to generate a plurality of sets of analysed data;
generating a partial intellectual property analysis report displaying said sets of analysed intellectual property data as graphics;
performing an interpretation of at least one of said graphics by an interpreter;
including intellectual property interpretation data resulting from said interpretation of said at least one graphic in said partial intellectual property analysis report to generate an intellectual property analysis report; and
providing said intellectual property report to said customer.

45. A method of providing an intellectual property analysis service to a customer, the method comprising:
retrieving intellectual property data from at least one database;
processing the retrieved intellectual property data to cleanse the data and to add associations between data entries before analysis;
selecting one of a plurality of templates defining a plurality of predetermined intellectual property analyses, or selecting a plurality of predetermined intellectual property analyses;
performing said predetermined intellectual property analyses on said processed intellectual property data to generate a plurality of sets of analysed data;
generating an intellectual property analysis report including said sets of analysed intellectual property data as graphics; and
providing said intellectual property report to said customer.

46. A method according to claim 45, wherein said retrieval of intellectual property data includes performing a manual search in at least one database for said intellectual property data.

47. A method according to claim 45, wherein said data cleansing includes unifying disparate entity names used for the same entities.

48. A method according to claim 45, wherein said processing includes adding corporation associations for corporation fields in the data entries to associate subsidiary companies with their parent companies to allow the related companies to be processed as a single entity.

49. A method according to claim 45, wherein said processing includes adding entity associations for entity fields in the data entries to associate entities to allow the associated entities to be processed in combination.

50. A method according to claim 45, including selecting one of plurality of a graphic types for at least one said graphic for use in the generation of said intellectual property analysis report.

51. A method according to claim 45, including modifying the appearance of at least one graphic after the generation of the intellectual property analysis report, and re generating the intellectual property analysis report in dependence upon the modifying user input.

52. A method according to claim 45, including inputting identifying text in standard text fields for identifying the subject of at least sections of the intellectual property analysis report.

53. A method according to claim 45, including performing an interpretation of at least one of said graphics by an interpreter; and including intellectual property interpretation data resulting from said interpretation of said at least one graphic in said intellectual property analysis report.

54. A method according to claim 45, wherein said intellectual property interpretation data is entered by an interpreter on a form based interface for inclusion in said intellectual property analysis report.

55. A method according to claim 45, wherein said intellectual property analysis report includes commercial, business and financial information.

56. A method according to claim 45, including providing said plurality of sets of analysed data to said customer.

57. A method of generating an intellectual property analysis report, the method comprising:
retrieving intellectual property data from at least one database;
processing the retrieved intellectual property data to cleanse the data and to add associations between data entries before analysis;
receiving a user selection of one of a plurality of templates defining a plurality of predetermined intellectual property analyses, or selecting a plurality of predetermined intellectual property analyses;
performing said predetermined intellectual property analyses on said processed intellectual property data to generate a plurality of sets of analysed data; and
generating an intellectual property analysis report including said sets of analysed intellectual property data as graphics.

58. A method according to claim 57, wherein said data cleansing includes unifying disparate entity names used for the same entities.

59. A method according to claim 57, wherein said processing includes adding corporation associations for corporation fields in the data entries to associate subsidiary companies with their parent companies to allow the related companies to be processed as a single entity.

60. A method according to claim 57, wherein said processing includes adding entity associations for entity fields in the data entries to associate entities to allow the associated entities to be processed in combination.

61. A method according to claim 57, including selecting one of plurality of a graphic types for at least one said graphic for use in the generation of said intellectual property analysis report.

62. A method according to claim 57, including modifying the appearance of at least one graphic after the generation of the intellectual property analysis report, and re generating the intellectual property analysis report in dependence upon the modifying user input.

63. A method according to claim 57, including inputting identifying text in standard text fields for identifying the subject of at least sections of the intellectual property analysis report.

64. A method according to claim 57, including receiving intellectual property interpretation data giving an interpreter's interpretation of said at least one graphic in said intellectual property analysis report and adding said intellectual property interpretation data to said intellectual property analysis report.

65. A method according to claim 57, wherein said intellectual property interpretation data is received from an interpreter on a form based interface for inclusion in said intellectual property analysis report.

66. A method according to claim 57, wherein said intellectual property analysis report includes commercial, business and financial information.

67. Apparatus for generating an intellectual property analysis report, the apparatus comprising:
a retrieval engine for retrieving intellectual property data from at least one database;
a data processor for processing the retrieved intellectual property data to cleanse the data and to add associations between data entries before analysis;
a user input device for receiving a user selection of one of a plurality of templates defining a plurality of predetermined intellectual property analyses, or selecting a plurality of predetermined intellectual property analyses;
an analysis engine for performing said predetermined intellectual property analyses on said processed intellectual property data to generate a plurality of sets of analysed data; and
a report generator for generating an intellectual property analysis report including said sets of analysed intellectual property data as graphics.

68. Apparatus according to claim 67, wherein said data processor is adapted to unify disparate entity names used for the same entities.

69. Apparatus according to claim 67, wherein said data processor is adapted to add corporation associations for corporation fields in the data entries to associate subsidiary companies with their parent companies to allow the related companies to be processed as a single entity.

70. Apparatus according to claim 67, wherein said data processor is adapted to add entity associations for entity fields in the data entries to associate entities to allow the associated entities to be processed in combination.

71. Apparatus according to claim 67, wherein said user input device is adapted to receive a user selection of one of plurality of a graphic types for at least one said graphic for use in the generation of said intellectual property analysis report.

72. Apparatus according to claim 67, including a graphic modifying engine to modify the appearance of at least one graphic after the generation of the intellectual property analysis report, and said report generator is adapted to re generate the intellectual property analysis report in dependence upon the modifying user input.

73. Apparatus according to claim 67, wherein said user input device is adapted to receive identifying text in standard text fields for identifying the subject of at least sections of the intellectual property analysis report.

74. Apparatus according to claim 67, including an interpreter's input device for receiving intellectual property interpretation data giving an interpreter's interpretation of said at least one graphic in said intellectual property analysis report.

75. Apparatus according to claim 74, wherein said interpreter's input device is adapted to receive said intellectual property interpretation data on a form based interface for inclusion in said intellectual property analysis report.

76. Apparatus according to claim 67, wherein said intellectual property analysis report includes commercial, business and financial information.

77. Apparatus for generating an intellectual property analysis report, the apparatus comprising:
retrieving means for retrieving intellectual property data from at least one database;
processing means for processing the retrieved intellectual property data to cleanse the data and to add associations between data entries before analysis;
receiving means for receiving a user selection of one of a plurality of templates defining a plurality of predetermined intellectual property analyses, or selecting a plurality of predetermined intellectual property analyses;
analysing means for performing said predetermined intellectual property analyses on said processed intellectual property data to generate a plurality of sets of analysed data; and
generating means for generating an intellectual property analysis report including said sets of analysed intellectual property data as graphics.

78. A method of providing an intellectual property analysis service to a customer, the method comprising:
selecting one of a plurality of templates defining a plurality of predetermined intellectual property analyses, or selecting a plurality of predetermined intellectual property analyses;
retrieving intellectual property data from at least one database in dependence upon intellectual property data required for the selected intellectual property analyses;
performing said predetermined intellectual property analyses on said retrieved intellectual property data to generate a plurality of sets of analysed data;
generating an intellectual property analysis report including said sets of analysed intellectual property data as graphics;
receiving a modifying user input to define a modified intellectual property analysis;
re generating the intellectual property analysis report in dependence upon the modifying user input; and
providing said intellectual property analysis report to said customer.

79. A method according to claim 78, wherein said retrieval of intellectual property data includes performing a manual search in at least one database for said intellectual property data.

80. A method according to claim 78, including cleansing the retrieved intellectual property data to unify the data format before analysis.

81. A method according to claim 80, wherein said data cleansing includes unifying disparate entity names used for the same entities.

82. A method according to claim 78, including processing the retrieved intellectual property data to add association data representing associations between data entries.

83. A method according to claim 82, wherein said processing includes adding corporation associations for corporation fields in the data entries to associate subsidiary companies with their parent companies to allow the related companies to be processed as a single entity.

84. A method according to claim 82, wherein said processing includes adding entity associations for entity fields in the data entries to associate entities to allow the associated entities to be processed in combination.

85. A method according to claim 78, including selecting one of plurality of a graphic types for at least one said graphic for use in the generation of said partial intellectual property analysis report.

86. A method according to claim 78, including inputting identifying text in standard text fields for identifying the subject of at least sections of the intellectual property analysis report.

87. A method according to claim 78, wherein said intellectual property analysis report includes commercial, business and financial information.

88. A method according to claim 78, including providing said plurality of sets of analysed data to said customer.

89. A method of generating an intellectual property report, the method comprising:
receiving a user selection of one of a plurality of templates defining a plurality of predetermined intellectual property analyses, or selecting a plurality of predetermined intellectual property analyses;
retrieving intellectual property data from at least one database in dependence upon intellectual property data required for the selected intellectual property analyses;
performing said predetermined intellectual property analyses on said retrieved intellectual property data to generate a plurality of sets of analysed data;
generating an intellectual property analysis report including said sets of analysed intellectual property data as graphics;
receiving a modifying user input to define a modified intellectual property analysis; and
re generating the intellectual property analysis report in dependence upon the modifying user input.

90. A method according to claim 89, including receiving a user selection of one of a plurality of a graphic types for at least one said graphic for use in the generation of said intellectual property analysis report.

91. A method according to claim 89, including processing the retrieved intellectual property data to cleanse the data before analysis.

92. A method according to claim 89, including processing the retrieved intellectual property data to add associations between data entries before analysis.

93. A method according to claim 89, including receiving intellectual property interpretation data giving an interpreter's interpretation of said at least one graphic in said intellectual property analysis report and adding said intellectual property interpretation data to said intellectual property analysis report.

94. A method according to claim 93, wherein said intellectual property interpretation data is received from an interpreter on a form based interface for inclusion in said intellectual property analysis report.

95. Apparatus according to claim 89, wherein said intellectual property analysis report includes commercial, business and financial information.

96. Apparatus for generating an intellectual property report, the apparatus comprising:
a user input device for receiving a user selection of one of a plurality of templates defining a plurality of predetermined intellectual property analyses, or selecting a plurality of predetermined intellectual property analyses;
a retrieval engine for retrieving intellectual property data from at least one database in dependence upon intellectual property data required for the selected intellectual property analyses;
an analysis engine for performing said predetermined intellectual property analyses on said retrieved intellectual property data to generate a plurality of sets of analysed data; and
a report generator for generating an intellectual property analysis report including said sets of analysed intellectual property data as graphics;
wherein said user input device is adapted to receive a modifying user input to define a modified intellectual property analysis; and said report generator is adapted to re generate the intellectual property analysis report in dependence upon the modifying user input.

97. Apparatus according to claim 96, wherein said user input device is adapted to receive a user selection of one of a plurality of a graphic types for at least one said graphic for use in the generation of said partial intellectual property analysis report.

98. Apparatus according to claim 96, including a data processor for processing the retrieved intellectual property data to cleanse the data before analysis.

99. Apparatus according to claim 96, including a data processor for processing the retrieved intellectual property data to add associations between data entries before analysis.

100. Apparatus according to claim 96, including an interpreter's input device for receiving intellectual property interpretation data giving an interpreter's interpretation of said at least one graphic in said intellectual property analysis report, wherein said report generator is operative to add said intellectual property interpretation data to said intellectual property analysis report.

101. Apparatus according to claim 100, wherein said interpreter's input device is adapted to allow said intellectual property interpretation data to be received on a form based interface for inclusion in said intellectual property analysis report.

102. Apparatus for generating an intellectual property report, the apparatus comprising:
receiving means for receiving a user selection of one of a plurality of templates defining a plurality of predetermined intellectual property analyses, or selecting a plurality of predetermined intellectual property analyses;
retrieving means for retrieving intellectual property data from at least one database in dependence upon intellectual property data required for the selected intellectual property analyses;
analysing means for performing said predetermined intellectual property analyses on said retrieved intellectual property data to generate a plurality of sets of analysed data; and
generating means for generating an intellectual property analysis report including said sets of analysed intellectual property data as graphics;
wherein said user input means is adapted to receive a modifying user input to define a modified intellectual property analysis; and said generating means is adapted to re generate the intellectual property analysis report in dependence upon the modifying user input.

103. A method of providing an intellectual property analysis service to a customer, the method comprising:
individually selecting a plurality of predetermined intellectual property analyses and/or a plurality of bespoke intellectual property analyses;
retrieving intellectual property data from at least one database in dependence upon intellectual property data required for the selected intellectual property analyses;
performing said predetermined intellectual property analyses on said retrieved intellectual property data to generate a plurality of sets of analysed data;
generating an intellectual property analysis report including said sets of analysed intellectual property data as graphics; and
providing said intellectual property report to said customer.

104. A method according to claim 103, including selecting to modify the appearance of at least one graphic after the generation of the intellectual property analysis report, and re generating the intellectual property analysis report in dependence upon the modifying selection.

105. A method according to claim 103, including selecting to define a modified intellectual property analysis to be performed after the generation of the intellectual property analysis report, and re generating the intellectual property analysis report in dependence upon the modifying selection.

106. A method according to claim 103, including cleansing the retrieved intellectual property data before analysis.

107. A method according to claim 103, wherein said intellectual property analysis report includes commercial, business and financial information.

108. A method according to claim 103, including providing said plurality of sets of analysed data to said customer.

109. A method of providing an intellectual property analysis service to a customer, the method comprising:
retrieving intellectual property data from at least one database;
reclassifying the retrieved intellectual property data;
performing said predetermined intellectual property analyses on said retrieved and reclassified intellectual property data to generate a plurality of sets of analysed data;
generating an intellectual property analysis report including said sets of analysed intellectual property data as graphics; and
providing said intellectual property report to said customer.

110. A method according to claim 109, wherein said reclassifying comprises reclassifying the retrieved intellectual property data using classifications based on products produced by a corporation or corporate structure or organisation.

111. A method according to claim 110, wherein said intellectual property analysis report includes commercial, business and financial information.

112. A method according to claim 110, including providing said plurality of sets of analysed data to said customer.

113. A method of generating an intellectual property analysis report, the method comprising:
retrieving intellectual property data from at least one database;
receiving reclassification data for the reclassifying of the retrieved intellectual property data;
performing said predetermined intellectual property analyses on said retrieved and reclassified intellectual property data to generate a plurality of sets of analysed data; and
generating an intellectual property analysis report including said sets of analysed intellectual property data as graphics.

114. A method according to claim 113, wherein said reclassification data comprises the retrieved intellectual property data reclassified using classifications based on products produced by a corporation or corporate structure or organisation.

115. Apparatus for generating an intellectual property analysis report, the apparatus comprising:
a retrieval engine for retrieving intellectual property data from at least one database;
a reclassification engine for receiving reclassification data and for reclassifying the retrieved intellectual property data using the received reclassification data;
an analysis engine for performing said predetermined intellectual property analyses on said retrieved and reclassified intellectual property data to generate a plurality of sets of analysed data; and
a report generator for generating an intellectual property analysis report including said sets of analysed intellectual property data as graphics.

116. Apparatus according to claim 115, wherein said reclassification engine is adapted to reclassify the retrieved intellectual property data using classifications based on products produced by a corporation or corporate structure or organisation.

117. Apparatus for generating an intellectual property analysis report, the apparatus comprising:
retrieving means for retrieving intellectual property data from at least one database;
receiving means for receiving reclassification data and for reclassifying of the retrieved intellectual property data using the received reclassification data;
analysing means for performing said predetermined intellectual property analyses on said retrieved and reclassified intellectual property data to generate a plurality of sets of analysed data; and
generating means for generating an intellectual property analysis report including said sets of analysed intellectual property data as graphics.

118. Apparatus according to claim 117, wherein said receiving means is adapted to receive reclassification data classifying the retrieved intellectual property data using classifications based on products produced by a corporation or corporate structure or organisation.

119. A method of generating an intellectual property analysis report, the method comprising:
receiving a user input defining a report to be generated;
retrieving first intellectual property data from at least one database in dependence upon intellectual property data required for the report;
identifying second intellectual property data cited in the retrieved intellectual property data and/or citing the retrieved intellectual property data;
retrieving said second intellectual property data from at least one database;
associating the second intellectual property data as citation intellectual property data for said first intellectual property data;
analysing said first and second intellectual property data to generate analysed intellectual property data; and
generating an intellectual property analysis report displaying said analysed intellectual property data as graphics.

120. Apparatus for generating an intellectual property analysis report, the apparatus comprising:
an input device for receiving a user input defining a report to be generated;
a search engine for retrieving first intellectual property data from at least one database in dependence upon intellectual property data required for the report;
a citation processor for identifying second intellectual property data cited in the retrieved intellectual property data and/or citing the retrieved intellectual property data;
wherein said search engine is adapted to retrieve said second intellectual property data from at least one database; and said citation processor is adapted to associate the second intellectual property data as citation intellectual property data for said first intellectual property data;
an analysis engine for analysing said first and second intellectual property data to generate analysed intellectual property data; and
a report generator for generating an intellectual property analysis report displaying said analysed intellectual property data as graphics.

121. Apparatus for generating an intellectual property analysis report, the apparatus comprising:
means for receiving a user input defining a report to be generated;
means for retrieving first intellectual property data from at least one database in dependence upon intellectual property data required for the report;
means for identifying second intellectual property data cited in the retrieved intellectual property data;
means for retrieving said second intellectual property data from at least one database;
means for associating the second intellectual property data as citation intellectual property data for said first intellectual property data;
means for analysing said first and second intellectual property data to generate analysed intellectual property data; and
means for generating an intellectual property analysis report displaying said analysed intellectual property data as graphics.

122. A method of citation analysis for intellectual property, the method comprising:
retrieving data for intellectual property from at least one database;
retrieving data for citation intellectual property cited by and/or citing the retrieved intellectual property from at least one database, the data including information on the owner of said citation intellectual property; and
performing a semantic analysis on the intellectual property data for the citation intellectual property to determine pertinent intellectual property in said citataion intellectual property.

123. A method of identifying potential licensees and/or licensors for intellectual property for a company, the method comprising performing the method of citation analysis as claimed in claim 122 for the company's intellectual property, and identifying the owners of the pertinent intellectual property as potential licensees and/or licensors.

124. A method of providing an intellectual property service to a customer wishing to identify potential licensees and/or licensors for intellectual property, the method comprising:
retrieving data for intellectual property owned by the customer from at least one database;
retrieving data for citation intellectual property cited by and/or citing the customer's intellectual property from at least one database, the data including information on the owner of said citation intellectual property;
performing a semantic analysis of the intellectual property data for the citation intellectual property to determine pertinent intellectual property in said citation intellectual property;
identifying the owners of the pertinent intellectual property as potential licensees and/or licensors;
generating a report based on the identifications of the owners of the pertinent intellectual property; and
providing the report to the customer.

125. Apparatus for identifying potential licensees and/or licensors for intellectual property for a customer, the apparatus comprising:
a search engine for retrieving data for intellectual property owned by the customer from at least one database; and for retrieving data for citation intellectual property cited by and/or citing the customer's intellectual property from at least one database, the data including information on the owner of said citation intellectual property;
an analysis engine for performing a semantic analysis of the intellectual property data for the citation intellectual property to determine pertinent intellectual property in said citation intellectual property; and
an output device for outputting information on the owners of the pertinent intellectual property as potential licensees and/or licensors.

126. Apparatus for identifying potential licensees and/or licensors for intellectual property for a customer, the apparatus comprising:
means for retrieving data for intellectual property owned by the customer from at least one database; and for retrieving data for citation intellectual property cited by and/or citing the customer's intellectual property from at least one database, the data including information on the owner of said citation intellectual property;
means for performing a semantic analysis of the intellectual property data for the citation intellectual property to determine pertinent intellectual property in said citation intellectual property; and
means for outputting information on the owners of the pertinent intellectual property as potential licensees and/or licensors.

127. A carrier medium for carrying computer readable code for controlling a computer to carry out the method of any one of claims 1, 57, 89, 103, 113, 119, or 122.
